(19) United States
(12) Patent Application Publication
(10) Pub. No.: US 2001/0037284 A1
(43) Pub. Date: Nov. 1, 2001

(54) Negotiated right exchange system and method

(76) Inventors: Ephraim Brian Finkelstein, Monsey, NY (US); Ken M. Blackstein, Lakewood, NJ (US); Kenneth D. Nakdimen, Monsey, NY (US)

Correspondence Address: Steven M. Hoffberg, Esq, MILDE, HOFFBERG & MACKLIN, LLP, SUITE 460, 10 BANK STREET, WHITE PLAINS, NY, 10606, US

(21) Appl. No.: 09/818,483

(22) Filed: Mar. 27, 2001

Related U.S. Application Data
(60) Provisional application No. 60/192,486, filed on Mar. 27, 2000.

(51) Int. Cl. G06F 17/60

(52) U.S. Cl. 705/37

(57) ABSTRACT

A repurchase agreement trading system comprising a plurality of trading terminals, each having a user interface comprising a display and keyboard, and a central processor, for establishing communications between said trading terminals, wherein each of said trading terminals presents a hierarchal list of repurchase agreement opportunities, and wherein a user at a trading terminal can select one of said repurchase agreement opportunities and communicate directly with a potential repurchase agreement counterparty about the respective repurchase agreement opportunity.

### FIELD OF THE INVENTION

The present invention relates to a system and method for implementing an exchange for rights and instruments which require negotiations between the parties thereto, including Repurchase Agreements, also known as “Repos”, and securities lending transactions.

### BACKGROUND OF THE INVENTION

A repurchase agreement (“repo”) is a contract involving the simultaneous sale and future repurchase of an asset, most often treasury securities or high quality liquid notes. Under the terms of the agreement, one party sells the securities and agrees to buy them back at a price that reflects the funding rate associated with the underlying security. As such, repos represent an instrument whereby one can invest short term cash in high yielding securities while incurring minimum risk. The funding rate is distinct from and unrelated to the yield associated with the security.

Repos were originally developed by US securities houses, which had a requirement to fund their natural long positions in fixed income securities. As their credits on a stand-alone basis did not allow them to borrow at attractive levels, the idea of pledging collateral out of their long position gained hold. The market has grown dramatically and now constitutes a very attractive investment alternative to other short term investments.

Another presentation of the repurchase agreement is where a potential lender offers to loan against certain securities, called a reverse repurchase agreement or “reverse”. In some cases, this results from a requirement to cover a short in those particular securities. In other cases, this is part of a particular strategy. The U.S. Federal Reserve Bank (“Fed”) may also seek to control the money supply through these practices. The repurchase transaction can thus also be used to acquire specific securities for a short term basis. For example, an account might be required to borrow a specific bond, which it has shorted in the cash market, in order to make proper delivery. As such, the account could then negotiate a repo rate and term in order to acquire this specific bond from a counterparty. In this case, the rate for this “special” identified issue may differ from market rates for comparable, but distinct securities. In this situation, the notable feature of the repo transaction is the supply and demand for the underlying security. The market for “special” repo has its own specific factors which influence the pricing of the instrument. Moreover, the market for special repo may diverge from the general trend in short term interest rates. This repo market displays considerable volatility, and consequently, can be strategically used for capital gains based on anticipation of changes in special repo rates or which fixed income issues will soon trade “special” in the repo market.

A repurchase agreement (repo) is a thus sale of securities (typically US government fixed income securities, but potentially any type of instrument) to a “lender”, with an agreement to buy them back in the future. While the legal transaction is structured as a paired purchase of securities and forward sale of securities, the intent of the parties is typically to effect a secured loan with the securities being the collateral. Since the lender holds the borrower's securities as collateral, the risk of loss as a result of default by the borrower is controlled. Likewise, the risk by the borrower of default by the lender in returning the securities will also be controlled. As a result of these controlled risks, the transaction costs of the repurchase agreement are low, and the borrowing rate tends to be favorable. The term of a repo is variable, and may be, for example, a single day, a stated period, e.g., a week or a 30 days, or until maturity. The interest rate may be defined by an increased purchase price or a separate interest payment.

In an overnight repurchase agreement for U.S. Treasury Bills (“T-bills”), the transaction is structured such that the seller agrees to repurchase the T-bills on the next day at a higher price. The annualized “overnight repo rate” is calculated as follows:

repurchase price=sale price/(1+repo rate/360)

In an overnight repo, the rate may be renegotiated each day, or the agreement cancelled.

In the repo markets, the lender is generally considered to be the party at greater risk, so that a margin or “haircut” many times is imposed on the borrower. The borrower therefore must deposit or place at the disposal of lender collateral equal to a percentage greater than the amount loaned. This haircut is typically about 1-2%, although it is subject to negotiations. Over time, the value of the collateral is subject to change. Thus, lenders typically require that the collateral be repriced daily, and the margins readjusted.

The overnight repo rate is typically slightly above the Federal Reserve Bank overnight loan rate (Fed rate). Thus, a borrower is able to obtain a low rate, without requiring direct access to the Fed. On the other hand, the lenders achieve a return slightly higher than the Fed rate.

Repos allow a high degree of leverage, since a securities holder may purchase additional securities with the borrowed funds. Likewise, the lender may itself loan (or sell) the collateral securities during the repo term, subject to the requirement of returning identical issue or equivalent securities to the borrower upon termination of the agreement.

While the essential transaction of a repurchase agreement has low intrinsic risk, the large monetary amounts involved and the ability to efficiently conduct chained transactions allow escalation of risk. For example, these securities became notorious recently in the Orange County bankruptcy, in which the practice of pyramiding repurchase agreements coupled with the sudden reversal from several years of declining interest rates to a few months of rising rates was the principal cause of huge loses in the portfolios managed by the county. The county would buy US government bonds and then enter into a term repo with an investment banker. In return for the bonds, the county received cash, which it would use to buy more bonds. In effect, this meant that for every dollar originally invested it owned two dollars worth of bonds, thereby doubling its interest rate risk.

Since it is possible for either party to improvidently play the market, repurchase agreements all include an element of counterparty risk. Thus, the repurchase agreement is not itself a commodity, and indeed the terms of the agreement may be negotiated separately between parties. In negotiating a repo, therefore, the relevant factors include not only the identification of collateral and associated financial and security terms, but also the identity and reputation of the respective parties to the transaction.

Because the repo represents a negotiated legally enforceable right, the consummated repo agreement necessarily entails a contract between the parties. Counterparties to repo transactions typically enter into blanket agreements, which cover a series of transactions between the parties, with standard terms. These blanket agreements, in turn, are generally of standardized form, but are subject to variation and individual negotiation. Each individual transaction therefore is memorialized with the specific details of the transaction in the form of a trade ticket, identifying the collateral, pricing, term, and counterparties, which is subject to the blanket agreement encompassing the legal rights and remedies of the parties. Due to International issues and multiple competing standardizing authorities, a global standard repo agreement does not exist.

The U.S. Bankruptcy Code, 11 USC §559 (Contractual right to liquidate a repurchase agreement), was enacted to address the risk in the event that one party to the repurchase agreement seeks protection under the Bankruptcy Act. This section provides that the exercise of a contractual right of a repurchase agreement participant to cause the liquidation of a repurchase agreement (due to a condition specified in 11 USC §365(e)(1)) is not be stayed, avoided, or otherwise limited by the Bankruptcy Act unless, where the debtor is a stockbroker or securities clearing agency, such order is authorized under the provisions of the Securities Investor Protection Act of 1970 or any statute administered by the Securities and Exchange Commission. 11 USC §559 also provides that, in the event that a repurchase agreement participant liquidates one or more repurchase agreements with a debtor, and under the terms of one or more such agreements has agreed to deliver assets subject to repurchase agreements to the debtor, any excess of the market prices received or liquidation of such assets (or if any such assets are not disposed of on the date of liquidation of such repurchase agreements, at the prices available at the time of liquidation of such purchase agreements from a generally recognized source or the most recent closing bid quotation from such a source) over the sum of the stated repurchase prices and all expenses in connection with the liquidation of such repurchase agreements, shall be deemed property of the bankrupt estate, subject to the available rights of setoff. The term “contractual right” includes a right set forth in a rule or bylaw, applicable to each party to the repurchase agreement, of a national securities exchange, a national securities association, or a securities clearing agency, and a right, whether or not evidenced in writing, arising under common law, under law merchant or by reason of normal business practice. This section is therefore intended to allow the parties to a repurchase agreement to liquidate collateral to clear the debt, thus expeditiously freeing the lender's secured assets.

Presently, the total volume of overnight repurchase agreements is in excess of about 1.5 trillion dollars. However, while the maintenance of internal portfolios and clearance of these agreements is automated, the matching of buyer and seller, in the manner of an exchange, remains primarily a manual process. This is for two reasons: first, since counterparty risk cannot be ignored, the repo transaction does not represent a completely fungible commodity. Second, a participant in a repo transaction may seek some degree of anonymity, in order to prevent publication of its market positions and intentions. Thus, a relatively small group of traders within the U.S. control the broker/dealer and investment banking aspects of the domestic repo markets.

The repo/reverse markets are, in fact, international in scope, and cover not only U.S. Treasury obligations, but also commercial paper, bank obligations, foreign government obligations, European money market transactions, and the like.

There are a number options for a repo, including Open repo, which are term transactions where the continuity of the transaction is contingent upon a mutual agreement on the interest rate and term of the repurchase agreement (i.e., is terminable at will); Flex repo, which is a term repurchase agreement that provides for principal drawdowns prior to its final maturity and Index Repo, which is a term repo where the interest rate is reset periodically as a function of a short term rate index. The Flex repo agreement is generally considered best suited for financings where there will be cash flow uncertainty and a need for a fixed reinvestment rate. These repos can be useful instruments for issuers of floating rate securities who wish to match their asset and liability book.

A securities lending transaction is analogous to a repo, but is governed by a different type of agreement. The underlying securities may be equity or debt instruments.

Traditionally, traders and investors who desired to buy or sell equity securities, placed orders with brokers who traded on the floor of organized stock exchanges, such as the New York Stock Exchange or the NASDAQ market. Various companies and exchanges operate computerized crossing networks, also called anonymous matching systems. By way of example, crossing networks used in connection with the trading of financial instruments are disclosed in U.S. Pat. No. 4,412,287, which discloses an automated stock exchange in which a computer matches buy and sell orders for a variety of stocks; U.S. Pat. No. 3,573,747, which discloses an anonymous trading system for selling fungible properties between subscribers to the system; U.S. Pat. No. 3,581,072, which discloses the use of a computer for matching orders and establishing market prices in an auction market for fungible goods; U.S. Pat. No. 4,674,044, which discloses an automated securities trading system; U.S. Pat. No. 5,136,501, which discloses an anonymous matching system for effectuating trades through automatic matching in which buyers and sellers who are willing to trade with one another based on specified criteria, such as price, quantity and credit, may automatically trade when matching events occur satisfying these criteria; U.S. Pat. No. 5,101,353, which discloses an automated system for providing liquidity to securities markets in which orders are entered by the system and executed in real time either internally between system users or externally with stock exchanges and markets; and U.S. Pat. No. 5,727,165, expressly incorporated herein by reference, which discloses a matching system for trading instruments in which the occurrence of automatically confirmed trades is dependent on match acknowledgement from all counterparties to the matching trade, each of which is expressly incorporated herein by reference.

See also, U.S. Pat. Nos. 6,144,947, 6,119,093, 6,105,005, 6,076,074, 6,018,721, 5,991,743, 5,802,499, 5,717,989, and 5,563,783, each of which is expressly incorporated herein by reference.

Crossing networks have a number of advantages, including: (a) traders need not search for a contraparty (counterparty); and (b) anonymity is preserved. Known facilities for crossing trades include Instinet's Crossing Network and POSIT (Portfolio System for Institutional Trading) which is owned by ITG, Inc. The Instinet Crossing Network has an equities trading service to match buyers and sellers anonymously at set times. Computers pair buyers with sellers on a time priority basis. Trades are executed at the closing price for exchange-listed issues, and at the midpoint of the inside market (best bid and ask) for OTC issues. POSIT, for example, enables large investors to trade baskets of stocks among themselves. The orders are sent to a central computer where they are electronically matched with other orders. Unlike Instinet's Crossing Network, POSIT crosses are done at discreet times during the trading day. The prices are obtained from those quoted on the exchanges, a practice known as “parasitic pricing.” See, “Reshaping the Equity Markets, A Guide for the 1990s” by Robert A. Schwartz, Harper Business, 1991, especially at pp. 93-95.

Instinet, owned by Reuters, also operates an electronic trading system that facilitates the negotiation of trades between institutional investors and brokers. Instinet allows parties to trade anonymously, entering bids and offers electronically. Instinet subscribers can respond to an “order” entered into the system either by matching a displayed price or by making a counter bid or offer that is transmitted electronically to the counter parties. The trades that result from these negotiations become public information only when they are executed. This procedure provides an alternative to the direct human-to-human negotiation of orders in the upstairs market or on the trading floors. Instinet provides a limit order book for over-the-counter (OTC) securities and listed securities and also provides inside quotes for exchange listed securities for the seven U.S. exchanges on which stocks can be traded and for NASDAQ listed securities.

A major problem encountered in the design of crossing networks is that of determining how to match buyers and sellers. Existing approaches to this problem include (a) take-out strategies, where overlapping bids and offers are matched at the midpoint of the overlapped bid and ask prices, with priority given to buyers and sellers in order of price. This assumes a significant quantity of non-disclosed orders in the system; otherwise, there would be no incentive for overlap, and take-out would start at the disclosed best bid/offer prices, just like the Instinet book; (b) Single price auction strategies, where a single, size-weighted average price is computed from overlapping bid and offer prices, and everyone is filled at that price. Again, traders would have to be confident of a significant number of non-disclosed orders in the system to have the incentive to enter orders at a better price than the best disclosed price; and (c) premium strategies (as in the Chicago MMX system), where bids and offers have an associated positive or negative premium, and crossing takes place at the midpoint of market spread or at the minimum necessary premium differential from the midpoint, with priority given in order of premium. Here, the premium-based priority in matching provides the incentive for offering higher premiums. Each of these approaches is a batch process that relies upon ad hoc rules of competition among a relatively small set of discrete orders as being the means of arbitrating the crossing network participants'buy/sell entries.

Price discovery is an important market feature, but in many markets, is often not explicit. The call market opening procedure used on the NYSE, for example, enables determination of an opening price. Further, consolidation of the public order flow on the trading floor of the NYSE gives the exchange specialists a more comprehensive knowledge of buy/sell propensities in the broader market for an issue. The OTC market does not have an explicit price discovery mechanism, such as the call market opening procedure used by the NYSE. OTC dealers sense the public's buy/sell propensities by posting quotes and observing the market's response. Moreover, existing crossing networks use parasitic pricing methods, and therefore depend on the existence of another market in the same instruments.

Reuters' European patent applications EP 399 850, EP 407 026, and EP 411 748 disclose an automated matching system for anonymous trading of foreign currencies (or other financial instruments) in which a single host computer maintains a central data base consisting of all the trading instruments available for trade, credit information, and the various bids and offers that are present throughout the system. The host computer uses information in its central data base to match active bids and offers (as well as executing any transitory “hit bid” and “take offer” transactions) based on matching criteria which include the gross counterparty credit limit between counterparties to a potential matching transaction, price, and available quantity. To that end, each client site establishes and may subsequently vary or reset a credit limit for each possible counterparty, which is used by the host computer to establish the gross counterparty credit limit for each possible pair of parties and which is equal to the minimum of the remaining credit (initial credit limit less any applicable transactions that have already been executed) from the first party to the second party and from the second party to the first party. The host computer blocks completion of an otherwise eligible matching transaction between a given pair of potential counterparties when the transaction has an associated value in excess of the applicable gross credit limit. In that system, the various client site computers (keystations) merely maintain and display a restricted subset of the information available at the central computer, such as a predetermined number of the best bids and offers, and communicate credit and other transaction oriented information to the host computer for execution. However, in an attempt to preserve the anonymity of the parties, the client sites do not have access to any credit limits set by their possible counterparties, or even to the identification of any other party to a particular transaction until after a transaction has been completed.

Thus, in the Reuters system, confidential counterparty credit limit data is maintained in real time and utilized as part of the trade matching process by a central host computer. As a consequence, each client site has no way to determine, prior to committing to buy or sell at a displayed price from one or more anonymous counterparties, whether it is in fact eligible to respond to any of the bids or offers currently being displayed. Consequently, unless he attempts to execute a trade at the best price currently displayed on his screen, a trader using an existing anonymous matching system has no way of knowing whether he has credit with, and is willing to extend credit to, the anonymous counterparty offering (bidding) the best price currently displayed on his screen and thus whether any attempt to buy or sell at the displayed price will be subsequently invalidated by the system for lack of such credit.

U.S. Pat. No. 5,373,055, expressly incorporated herein by reference, provides an anonymous trading system which can identify the best bids and offers from those counterparties with which each client site is currently eligible to deal, while maintaining the anonymity of the potential counterparty and the confidentiality of any specific credit limitations imposed by the anonymous potential counterparty. To that end, each client site provides the system with only limited credit information for each potential counterparty (for example, a one bit flag indicating whether a predetermined limit has already been exceeded) and each bid or offer for a particular type of financial instrument is preferably prescreened by the system for compatibility with that limited credit information before calculating an anonymous “Dealable” price, for presentation to any of the traders dealing with that particular financial instrument. The prescreening is a simple check to determine whether any credit remains between the two possible counterparties to the potential transaction, and thus may be performed using a simple yes/no Preauthorization Matrix before any bid or offer is transmitted to a particular client site. Such Preauthorization Matrices are maintained at each of several regional nodes of a distributed processing communication network, with each such distributed regional node being connected by corresponding individual permanent links of the network to those client sites for which it is responsible for distributing market information including customized “Dealable” bid and offer prices in addition to global “Best” prices. The sensitive credit limit data indicating how much credit a particular client site is willing to extend to each possible counterparty is maintained only at a client site associated only with that particular client, and only a simple yes/no indication of whether the entity (for example, a trader, a trading floor, or a bank) associated with that particular access node is willing to transact business with a particular counterparty is transmitted to the other nodes of the communication network. To further limit the data received and processed by each of the relevant distribution nodes computers, (i.e., the regional nodes closest to the particular site and/or closest to the particular counterparty), only changes in the credit state between a particular access node and a particular counterparty (i.e., credit is no longer available or credit is now available) are transmitted to the distribution nodes, and any credit state information only relevant to transactions between two client sites both associated with other distribution nodes, may be altogether ignored. Thus, in this system, available counterparty credit is considered a threshold, rather than a factor, which may be dealt with by altering other deal parameters, such as haircut.

Communication systems for communicating between securities traders are well known, and include telephone, videoconferencing, and electronic digital data communications systems. See, U.S. Pat. Nos. 5,195,031, 5,034,916, 4,531,184 and 4,525,779, expressly incorporated herein by reference, which describe systems for providing interactive conversational type of video communication between pairs of uses or subscribers, as well as enabling multiple conversations to be carried out by a given user or subscriber in real-time and in association with data-base retrieval of supplementary data, such as in the commercially available Reuters Dealing System employed for commodity dealing such as in the money market. In such systems, such as in the money market, speed of contact is important in initiating and making deals usually involving substantial sums of money where slight delays can result either in a lost deal or a substantial variation in exchange rate.

U.S. Pat. No. 6,016,482 (Molinari, et al. Jan. 18, 2000), expressly incorporated herein by reference, relates to an enhanced collateralized funding processor, for use within an institution. A computer system is provided for implementing, managing and tracking financial transactions, including assessing and discounting of collateral, including repurchase agreements. The system includes means for receiving collateral data from a financial institution outside of the system and for comparing the received collateral data with the inputted transaction data and automatically outputting an error message if the data are not equal.

U.S. Pat. No. 5,742,775 (King, Apr. 21, 1998) expressly incorporated herein by reference, relates to a method and apparatus of creating financial instrument and administering an adjustable rate loan system. The terms of the loan are negotiated between counterparies.

U.S. Pat. No. 5,924,083 (Silverman, et al., Jul. 13, 1999), expressly incorporated herein by reference, relates to a distributed matching system which generates and provides to trading entities a market view display including a predetermined number of bids and offers of multiple trading instruments available to each individual trading entity based on unilateral and/or bilateral credit availability between the offeror/bidder and the viewing trading entity and the quantity available to the trading entity based on available unilateral or bilateral credit. The displayed market book may consist of individual order prices and quantities, aggregated prices and quantities, and/or average prices at predetermined quantities. The real-time credit filtered market view display information includes the predetermined number of unilaterally and/or bilaterally credit filtered orders and corresponding available quantities. The displayed market view may consist of individual order prices and quantities, aggregated prices and quantities, and/or average prices at predetermined quantities chosen by the viewing trading entity.

Automated dealing systems (e.g., for trading currencies, commodities, and the like) are increasingly replacing the conventional manner of dealing using a broker as an intermediary. When a broker is used to complete a transaction, it is possible for one or both of the counterparties to remain anonymous, or at least until just before the transaction is consummated, although this may impact the legal status of the broker. The broker can be relied upon to prevent one party from initiating or accepting a deal with another party with whom, for one reason or another, it does not wish to trade. Removal or automated implementation of such human safeguards has lead to the development of automated checks and validations in the automated dealing systems. A number of anonymous distributed matching systems currently exist which automatically match offers and bids entered by trading entities and allow trading entities to view the market and choose from among the displayed offers and/or bids. One such system is described in U.S. Pat. No. 5,077,665, expressly incorporated herein by reference, wherein a host computer maintains a host book data base including all active bids and offers in the system and distributes a subset of the host book, a keystation book, to the trader keystation. The contents of the keystation books includes an associated depth display range which is dynamically controllable by the host computer. The keystation book is also dynamically updated by transaction update broadcast messages received from the host computer. However, this system does not include any means by which credit availability between parties may be checked.

U.S. Pat. No. 5,077,665, expressly incorporated herein by reference, thus provides a matching system for trading instruments in which bids are automatically matched against offers for given trading instruments, for automatically providing matching transactions in order to complete trades for the given trading instruments in which controllable subsets of a distributable system trading book may be selectively provided to trading keystations in the matching system from the host computer or central system for controllably masking the available trading market. The disclosed system comprises the host computer for maintaining a host book data base comprising all of the active bids and offers in the system by trading instrument, a transaction originating keystation at a client site for providing a bid on a given trading instrument to the system for providing a potential matching transaction, a counterparty keystation for providing an offer on the given trading instrument involved in the potential matching transaction, and a network for interconnecting the host computer, the transaction originating keystation and the counterparty keystation in the system for enabling data communication therebetween. The content of each of the keystation books has an associated display depth range which in controllable by the host computer and is updatable by transaction update broadcast messages received from the host computer through the network. The host computer processes the matching transaction for a given trading instrument in time order entry to the matching system. The subset keystations books comprise accumulated summaries of corresponding bids and offers in the host book, with the summaries comprising an accumulation of common price bids and an accumulation of common price offers. The keystation book, comprises displayable data having a defined keystation book display depth range, such as the best bid or offer, the next best bid or offer, and so forth, and bids and offers which fall outside that display depth range are not displayed. These bids and offers contained in the keystation books are anonymous prior to the completion to the matching transaction. In this regard, preferably a display depth of one for the keystation books would prevent looking into the host book at the keystation. The broadcast messages from the host or central system are broadcast to all of the keystations in the matching system and are used to update the keystation books, whereas the directed messages which are sent from the central system or host are directed back only to the keystations involved in the actual matching transaction. These directed messages are used to update the local entry data base or order book at the local keystations involved in the transaction so as to indicate what has happened to the offer or bid at that particular keystation made in the connection with the matching transaction. Thus, by employing the distributed matching system of the present invention, controllable subsets of a distributable system trading book may be selectively provided to the various trading keystations in the matching system from the host or central system in order to controllably mask the available trading market and efficiently transmit only the required matching information to those keystations which require it.

To accommodate the need for some form of credit checking ability in the distributed matching system disclosed in U.S. Pat. No. 5,077,665, a distributed matching system including a credit checking feature was developed as described in U.S. Pat. No. 5,136,501, expressly incorporated herein by reference. The system described in this patent includes a credit feature by which credit availability between parties to a transaction is checked after a trading entity has selected a desired bid or offer and a match has been executed. Prior to sending a confirmation of the transaction to each party, the system performs a bilateral credit check to insure that each party has extended sufficient credit to the other to cover the amount of the transaction. However, a drawback of the system described in U.S. Pat. No. 5,136,501 is that is does not allow a trading entity to determine whether a displayed bid or offer is actually available in view of bilateral credit extended between the potential counterparties prior to selecting the displayed bid or offer. As a result, the trading entity is unsure whether a displayed bid or offer is really available until after the trading entity has requested the transaction. One possible solution to this problem is provided in U.S. Pat. No. 5,375,055, expressly incorporated herein by reference, wherein each trader's display is prescreened for compatibility with limited credit information. The limited credit information consists of a one-bit data flag indicating whether a predetermined credit limit between the potential trading parties is available. The system displays to the individual trading entity the best offer and/or bid price available to that trading entity for a predefined quantity based on the trading entity's credit. However, there are a number of limitations of the system described in U.S. Pat. No. 5,375,055. The system displays only the best prices available to the trading entity. There is no indication of what other bids and offers in the market are available to the trading entity, for example, bids and offers with slightly worse prices and bids and offers for which the quantity is less than the predefined quantity. As a result of the limited display of the system described in U.S. Pat. No. 5,375,055, transparency of the market, i.e., the degree to which trading entities have access to market information, is significantly less than, for example, in the distributed matching system described in U.S. Pat. No. 5,077,665 and U.S. Pat. No. 5,135,501. That is, the trader's display provides significantly less information about the aggregate activity of the market.

In addition, the system described in the prescreening of the display is accomplished using a credit matrix including one-bit flags which indicate whether a party's credit limit has been exceeded. Since the screening function is performed only on this basis and not on the basis of the actual amount of credit available between potential trading parties, the system described in the U.S. Pat. No. 5,375,055 is not capable of generating and displaying some types of desired market information, for example the quantity of an instrument available at a certain price as determined by the amount of credit available between trading parties. This system also fails to perform complex credit calculations wherein multiple credit limits are applied to a single order and/or wherein a single credit limit is distributed among multiple orders.

U.S. Pat. No. 5,924,083 therefore proposed a distributed matching system wherein each trading entity receives a filtered market view display including a predefined number (depth) of available offer and bid prices for one or more particular trading instruments and the quantity available to the trading entity as limited by unilateral and/or bilateral credit availability. To generate this display, a plurality of intelligent nodes filter the bids and offers in the system to determine which offers and bids will be distributed to the individual trader keystations for display to the individual trading entities subject to unilateral and/or bilateral credit availability between the parties. The displayed market view may consist of individual order prices and quantities, aggregated prices and quantities, and/or average prices for predetermined quantities. The system according to the present invention also performs complex credit calculations, for example where a single credit limit is applied to multiple orders or multiple credit limits are applied to a single order. As a result, the system automatically provides individualized information about the activity of the market to the trading entity and performs complex calculations needed to provide a complete view of the potentially complex market options available to each trading entity, thus increasing market transparency.

U.S. Pat. No. 5,924,082 (Silverman, et al., Jul. 13, 1999), expressly incorporated herein by reference, relates to a negotiated matching system, which includes a plurality of remote terminals associated with respective potential counterparties, a communications network for permitting communication between the remote terminals, and a matching station. Each user enters trading information and ranking information into his or her remote terminal. The matching station then uses the trading and ranking information from each user to identify transactions between counterparties that are mutually acceptable based on the ranking information, thereby matching potential counterparties to a transaction. Once a match occurs, the potential counterparties transmit negotiating messages to negotiate some or all terms of the transaction. Thus, the negotiated matching system first matches potential counterparties who are acceptable to each other based on trading and ranking information, and then enables the two counterparties to negotiate and finalize the terms of a transaction.

Some known automated trading systems allow traders to enter credit information which is used to check the suitability of counterparties before the deal is completed and before the identity of the parties is revealed. One such system is described in U.S. Pat. No. 5,136,501 wherein, prior to the completion of a transaction, a credit check is performed to insure that each party is willing to extend sufficient credit to its potential counterparty. Another known trading system is described in European Patent Application 92303437.5 in which the system automatically matches offers and bids using credit ranking information entered by each trader. These and other known trading systems have a number of drawbacks. These systems, however, are only amenable to highly specified trading instruments in which all criteria on which a decision to trade is based are readily quantifiable and standardized in the industry and the system. For example, decisions to trade some types of highly specified financial instruments are based solely on the price of the instrument and the quantity available. These easily-defined criteria are easy to incorporate into an automated trading system. However, the known automated trading systems are not capable of accommodating types of financial instruments that are traded using more subjective, less-quantifiable criteria. For example, known automated trading systems do not provide traders with the opportunity to filter out potential deals with other traders who may be unacceptable trading partners on the basis of subjective criteria other than the party's credit, for example, geographic location or political or other competitive criteria. This has only been possible through the agency of a broker who may take into account his client's other types of less quantifiable, subjective criteria concerning parties his clients are willing to deal with while maintaining the anonymity of his clients. In these automated trading systems, once a trader has entered a bid or offer, the trader no longer has the discretion of negotiating the entered terms of the bid or offer. The system automatically executes trades when compatible offers and/or bids are found. In some systems, a trader may enter a “soft” offer or bid, wherein the trader retains the discretion to either execute or not execute the trade. However, the terms of such a soft offer or bid define the objective criteria that must be satisfied to create a firm offer or bid. The known systems provide no means by which a trader can input a mere “expression of interest” in a particular transaction wherein the trader need not provide predefined objective criteria which would make the expression of interest firm.

In other words, the known matching exchange systems are designed to execute firm transactions when the system locates a bid and offer that match based on detailed specific information concerning the terms of the bid and offer input by the users. These systems do not provide a means by which two parties who are potentially interested in dealing with one another may be introduced to one another based on preliminary information input into the system, and then allowed to negotiate the terms of a transaction using a communication link.

### SUMMARY OF THE INVENTION

The present invention provides an automated exchange system for instruments, such as repurchase agreements, reverse repurchase agreements, and securities lending transactions, which require negotiation between parties, or for example, represent contract rights involving delayed performance by one or both parties, and for which there is thus risk of non-performance. In contrast to existing financial instrument exchange systems, the system and method according to the present invention provide support for tracking and disclosure of parties to a transaction, and further, as a part of the facilitation of a transaction, provide means for real time communications between potential counterparties to facilitate negotiations.

A preferred embodiment of the invention provides four separate functions, which may be separated into two distinct “exchanges” or consolidated. First, a traditional dealer or institutional securities lender may seek to borrow against collateral. In this case, the creditworthiness of the dealer or securities lender and the class of collateral, as opposed to the particular collateral itself, are material factors in negotiations. Likewise, in a second function, an investor seeks to make a collateralized loan to a creditworthy institution, but is rather neutral as to the particular collateral as opposed to the specifics thereof. Thus, the first and second functions typically form a trading pair.

In a third function, a securities lender or dealer seeks to borrow money against particular collateral, and in fact the dealer or lender may have tarnished credit, or the particular collateral may command a premium over unspecified collateral. A corresponding fourth function supports an investor or dealer who seeks to borrow particular collateral, or is willing to loan against particularly identified collateral.

It is therefore seen that, in the first pair of functions, it is the credit of the parties that drives the transaction, and the collateral itself often remain unidentified. Thus, there is often a right of substitution given, allowing the securities lender to replace certain collateral with other collateral of the same class. In the second pair of functions, it is the particular collateral that drives the transactions, and therefore the collateral must be identified during the negotiation process.

The first function therefore provides a display screen for a user, typically a dealer or securities lender, having, in one screen portion, a sorted list of opportunities published by that user. These opportunities may include classes of collateral available for loan (repo or securities lending transactions) and proposed terms, or offer for reverse or corresponding securities borrowing transactions. When a potential counterparty, e.g., an investor, demonstrates interest in an opportunity, that opportunity is represented in a tree format in a display frame on the screen, with an identifier for each respective interested potential counterparty represented as a separate branch. Until the interest in that opportunity is first shown, however, the branch does not appear. Typically, the denominated user broadcasts an offer, which may be public, or associated with filter parameters to selectively define an audience. The offer, in this case, is typically an identification of the user, identification of collateral, term, rate, amount available, etc. The list of potential counterparties is derived from communications received from investors who respond to the published offer, and thus are engaged in open negotiations with the user.

The second function provides a display screen for a user, typically an institution or dealer, having, in one screen portion, a sorted list of opportunities seeking to generate interest of that user. In this case, the opportunities comprise offers to repo or reverse, or for securities lending or borrowing transactions, with an identification of the offeror, as well as a description of the class of collateral, term, rate, amount, etc. When a user demonstrates interest in an opportunity, for example by bidding, that opportunity is then represented in a tree format in a display frame on the screen, with an identifier of the opportunity. Thus, the first and second functions form a corresponding pair.

The third function provides a display screen for a user, typically a smaller dealer or securities lender, or an owner of a special issue, providing, in one screen portion, a sorted list of opportunities published by that user. In this case, the collateral is particularly identified, rather than classified. When a potential counterparty, e.g., a dealer, securities lender or borrower, etc., demonstrates interest in particular collateral, that collateral is represented in a tree format in a display frame on the screen, with an identifier for each respective interested potential counterparty represented as a separate branch. Until the interest in that collateral is first shown, however, the branch does not appear. Typically, the user broadcasts an offer, which may be public, or associated with filter parameters to selectively define an audience. The offer, in this case, is typically an identification of the particular collateral presented or desired, user, term, rate, amount available, etc. The list of potential counterparties is derived from communications received from investors who respond to the published offer, and thus are engaged in open negotiations with the user.

The fourth function provides a display screen for a user, typically a dealer, investor, or securities lender or borrower, who is interested in evaluating offers for transactions involving particular collateral. The display shows, in one screen portion, a sorted list of opportunities available, which may be filtered according to user-entered criteria, for example counterparty identification and/or particular collateral identification. In this case, the information provided with each opportunity generally includes counterparty identification, particular collateral identification, term, rate, amount, etc. When the user demonstrates interest in an opportunity, that opportunity is presented in a separate display frame of the user interface, on a list. If the user is searching, for example, to close a deal on particular collateral on the best terms, then the display frame may provide an aggregation of ongoing negotiations according to the collateral. On the other hand, if a user seeks to transact business with a particular counterparty, while evaluating different collateralized transactions, then the information in the frame may aggregates by prospective counterparty. In fact, using an expandable tree format, it is possible to selectively organize the information in various different ways, and even to have redundant display of opportunities under various categories. The user may thus filter opportunities broadly, before entry into the frame, and then organize the opportunities which are under negotiation.

A preferred embodiment also includes a display screen on an investor system, which an investor uses to review and respond to opportunities presented. It is noted that the term “dealer” “securities lender”, “investor”, etc., used herein are for convenience only, and any entity may assume any role, as permitted by the infrastructure. The infrastructure may require registration and/or qualification of user for various activities.

In order to filter the potentially numerous opportunities available on the system, the user seeking to evaluate opportunities, e.g., using the second or forth functions, may define a set of rules, either explicitly or implicitly, defining the scope of interests. These may be, for example, desired deal parameters or limits for a repo or securities lending transactions, or the collateral for a reverse. The preferred tree structure allows for formalized structuring of information, therefore making information presentation efficient. However, a plurality of structure may be provided, either individually or simultaneously.

According to a preferred embodiment, however, the tree of the first function provides a sorting by collateral class, the second function provides a sorting by offering counterparty, the third function provides a sorting by particular collateral, and the fourth provides flexible sorting by counterparty, collateral, algorithmic sorting priority, etc.

The first and second functions may be segregated into a separate exchange from the third and fourth, or these may be conducted within a single exchange. Since the information and valuations are somewhat different, and the considerations of offerors and bidders different, there will often be little crossover; however, a creditworthy dealer with a large amount of a particular issue may, for example seek to cross-list using the first and third functions. The advantage of crosslisting is that inventory and negotiations may be managed in a consolidated manner, increasing efficiency. Likewise, bidders may analyze collateral both by particulars and by class, thus employing both the second and fourth functions.

In the event of a reverse, the investor is considered the originator or root of the transaction, while for a repo, typically the investor will search for available previously listed collateral. Alternately, a potential lender may “advertise” availability of funding under certain broad conditions.

In closing a repo, it is typically necessary to disclose the identity of respective counterparties, unless an agent for undisclosed principal is involved, in which case the agent must be identified. Legal debate exists whether such an agent for undisclosed principal is personally liable in the event of default of the transaction; however. It is generally important to implement a properly collateralized transaction with perfected security interest, in order to minimize transaction risks. In other instrument types, the identity of the principal may be unnecessary or irrelevant.

Because the repo transaction is dependent on a respective party's credit, it is possible that two parties otherwise with the same negotiating posture would reasonably be treated differently. Therefore, creditworthy dealers and traders may serve an important role in maintaining market liquidity and low transaction costs. A party with unestablished or poor credit, or overexposure, i.e., is objectively credit impaired, or with outstanding transactions with a prospective counterparty at or near a counterparty exposure limit, e.g., is credit impaired with respect to another party, but appropriate collateral, may thus engage in the repo market by transacting through a party with established credit. This opens the repo market to a greater number of participants and larger volume, thus allowing for greater efficiencies. This is particularly the case with specials, where a larger market size will more closely represent the theoretical market, and help avoid scarcity of desirable issues. The repo exchange system according to the present invention provides greater opportunities for parties to enter the market, by providing a semiautomated exchange system, which, for example, provides access through a public network, such as the Internet.

Because of the continuing risk of nonperformance (and potential legal, transactional and delay costs even if the transaction is ultimately completed) an analysis of the credit worthiness of the potential counterparty is not prudently ignored, and thus the counterparties are properly disclosed during negotiation of a transaction. This is a significant difference from typical automated exchanges, wherein the transaction involves a commodity with no continuing relationship between the buyer and seller. the event that a weak party enters the market, the credit risk may be appropriately evaluated based on the identification, and steps taken to prevent losses, based on the communication.

According to the present invention, a dealer defines his role(s), available collateral, special collateral interests, counterparty rules, matched book and arbitrage interests, and the like. The exchange system then evaluates this private information, without a general publication thereof. In a preferred embodiment, a type and amount of collateral is broadcast, along with associated deal parameters, to the members of the exchange. For example, 100 million dollars of T-bills with 1 month to maturity at 6-5/32% overnight interest. This issue then appears in a pane on the display screen of dealers who have indicated a prior interest in such issue, sorted in order of interest priority based on previously input interest priorities. A potential counterparty may then communicate with the offeror, to negotiate deal terms. Typically, all major market entrants have preestablished repo agreements. Since these agreements are not identical, the value of the transaction between parties may differ. Thus, during the communication, the identity of the potential counterparty should be disclosed. The system may, after this identification, calculate various parameters and apply certain rules, such as limits on total counterparty exposure, discount rates, offsetting transactions, and the like. The potential counterparties may then engage in an on-line chat session, similar to the AOL Instant Messenger (AIM) chat window and Internet Relay Chat (IRC).

A party may, through the system, communicate with multiple potential counterparties simultaneously, seeking to negotiate the best deal. After acceptable deal parameters are negotiated, the deal is closed, and all inconsistent open negotiations are voided. It is noted that a trader may have multiple lots of an identical issue available. Thus, while larger lots typically yield higher values, this also discloses valuable market information to competitors. By publishing a smaller lot size, less information is made available to competitors. Thus, only after all available collateral is committed, are the remaining negotiations voided. Indeed, a participant may continue to sell collateral after inventory is expended, in order to establish a short position.

While the market for repo's is liquid and efficient, transactions typically involve negotiation of terms. Thus, a communication between potential counterparties is desired in order to come to terms. Further, in negotiating a transaction, a number of bidders may be involved, and thus multiple negotiations for the same collateral may be ongoing simultaneously. In order to administer these negotiations, a screen portion of a graphic user interface is preferably provided, organized by counterparty and/or collateral. A user (dealer or investor) may then keep track of negotiations using hierarchy, allowing the user to quickly switch between negotiations and analyze a status thereof. In one embodiment, the hierarchy is initially sorted by collateral class, e.g., US Treasuries, US Agencies, Mortgages, and then by dealer name (for an investor screen) or by other key (e.g., alphabetical, transaction size, proximity of bid and ask, etc.). For each listed collateral, there may be outstanding negotiations. An investor may then commence or continue negotiations for collateral, while a dealer must respond to negotiations, and does not initiate communications with investors. The negotiations are highly formalized and preferably entail a communication of a set of formatted parameters, representing a desired deal. The differences between the bid and ask may then be highlighted, or a free-form alphanumeric message passed between potential counterparties. When the terms (and respective counterparties) are accepted by both parties, the parties may then accept, and the deal be closed. The system preferably includes an automated trading ticket generator, with central logging.

Once deal parameters are finalized, the exchange system confirms the trade by generating reciprocal trade tickets, for the sale and forward purchase transactions. Preferably, the exchange system changes transaction fees that are based on the number of transactions and the value of the transaction, as well as market participation fees, software maintenance fees, and portfolio management software fees (as appropriate). Other fees may, of course, be imposed, in order to assure fairness of burden and to provide strength to the exchange itself. Typically, participants who are securities owners or lenders are benefited by a highly liquid market, other than those parties which profit principally as intermediaries or arbitragers. Thus, it is likely that only a single market exchange will exist.

Another aspect of the present invention is that it allows global trading, and thus is not limited to New York banking hours. This increased flexibility in closure of transactions will also tend to reduce price disparities and pure arbitrage opportunities. Of course, parties need not alter present practices, and, for example, U.S. Treasury issues will likely continue to be traded with New York according to the traditional schedule.

U.S. Pat. No. 6,012,046, expressly incorporated herein by reference, provides a computerized crossing network that allows traders to input as orders a satisfaction density profile and maximum size limit, which at once characterizes the trader's degree of satisfaction to trade at any and all prices and sizes, up to the aggregate (or size) limit, and that matches orders (as represented by each trader's satisfaction density profile) so that each trader is assured that the overall outcome of the process (in terms of average price and size of fill) has maximized the mutual satisfaction of all traders. Such a profile, to the extent it is static (and not dependent on dynamic market factors), is one way to enter and prioritize interests, and may be employed in accordance with the present invention. The satisfaction density profile of U.S. Pat. No. 6,012,046, used in an equities trading system, is a two-dimensional grid or matrix (which could also be represented as a two-dimensional graph or in another two-dimensional format), one dimension being price and the second dimension being size of transaction, that as a whole characterizes the trader's degree of satisfaction for a transaction at each (price, size) coordinate. Each element of the satisfaction density profile, called a satisfaction density value, indicates the trader's degree of satisfaction to trade that size order at that price.

According to an embodiment of the present invention, a user may enter priorities for sorting in the form of a similar satisfaction density profile, which serves to quantify the value of a respective transaction and allow sorting in accordance therewith. The user-entered parameters are, for example, the size of the trade, rate and type of collateral, and any appropriate or necessary parameter or factor, which of course are entered as in multi-dimensional format. Typically, while the rate will vary in dependence on market conditions, and the trade size and type of collateral based on the needs of the trader, the interrelation will often be persistent over time, facilitating definition of the profile without exhaustively defining each condition point for each trading condition. The profile may also be defined as an algorithm or vector (or matrix thereof), rather than a matrix of scalar values. Likewise, templates may be employed embodying a particular type of strategy, for selection and implementation, simplifying the task of generating the profile without negating its benefits. Once the satisfaction density profile is complete the profile may, for example, be employed by a central controller, or locally within the control of the trader, to sort available opportunities by priority. The profile may also be distributed (portions stored both locally and centrally), so that the private information contained therein in its complete form is maintained in secure fashion, yet the communication and processing burden on remote terminals is controlled. The satisfaction density profile may be dynamic, based on intrinsic or extrinsic market conditions, other pending negotiations, closed transactions, change over time, and the like.

If the profiles from a plurality of users are stored centrally, then an aggregate satisfaction density profile may be calculated, and published as a market indicator. The granularity of the market indicator may be high or low, or itself represented as a multidimensional representation. Thus, an embodiment of the present invention provides a set of market indicators derived from user's negotiating preferences, which may optionally include factors based on actual transaction closings.

If a user accurately provides sufficient information defining a satisfaction density profile for an intended transaction, then the system may provide further automation, up to an including the closure of a transaction. Thus, the semi-automated exchange may then become a matching system or automated exchange.

A similar system may be employed for trading in options. Typically, under static market, conditions, options based on underlying financial instruments or equities are handled by existing market infrastructures. On the other hand, where the market is volatile, published pricing for large blocks of options do not necessarily represent a price at which a transaction will close. Rather, each respective counterparty must judge instantaneous market position as well as longterm strategies, as well as possible hedge strategies which must close concurrently. However, closing the transaction may involve an identification of a suitable prospective counterparty for negotiation of final terms. The present embodiment with satisfaction density profiles therefore allows a party to enter an execute a complex strategy, which may include contingent offers, which may result in direct negotiation of parties. Existing exchanges for such instruments require that traders who are not principals to receive firm and specific bids or offers, without complex conditionalities, and do not permit negotiation between principals.

In the aggregate profile, the spread region has an arbitrary shape, which depends upon the aggregate of unfilled buy and sell satisfaction density profiles existing in the system at a given time. The shape of the spread region, when represented graphically or mathematically, indicates macro-features of the market in a given instrument. For example, a spread region that is narrow at small trade sizes and widens at larger trade sizes, indicates that the current market is primarily in small trades, with no large buy orders and sell orders that are close in price. On the other hand, if the spread region narrows at large sizes, this would indicate the presence of one or more large contra parties who are close in price. It is noted that, in the repo market, traders are quite sensitive about publishing strategies and weaknesses, and thus extrapolation from published data relating to unfilled orders may be poorly predictive of actual market conditions, and that data from closed trades may be useful, though delayed, indicator of the market. According to an embodiment the present invention, however, closed trades need not be published, and the data relating thereto may be unavailable. Thus, the ask/bid data may be the best information available, even if it is subject to manipulation by market makers. The reason closed trades need not be published is because, as a result of negotiations, respective counterparties may seek to close a trade outside a particular forum, and indeed, as the sensitivity of the information increases, the likelihood that the parties will seek secrecy also increases.

According to one embodiment of the invention, a commission or fee is charged based on trades executed as a result of the use of the exchange system. In order to assure that the fees or fee structure is not circumvented, a number of options are available. For example, in a three party transaction, the intermediate party may be associated with or controlled by the exchange system, or otherwise provide reports. Thus, a transaction involving the collateral between respective parties would become known, and the history of negotiations leading to the transaction identified. Alternately, once a user posts a bid or offer, a commission or fee will be due thereon, unless, for example, no acceptances meeting the bid or offer criteria are recorded. Since use of the exchange has a value, and alternative methods have associated costs, the incentive to bypass the exchange system can be made low.

The fee structure may be, for example, based on the economic value of the securities, number of listings, a percentage of portfolio value, or other such scheme based on transaction value or volume. Alternatively, a flat fee may be imposed for participation, for example, a membership fee, or monthly or annual recurring usage fee. Hybrid compensation schemes are also possible.

A further attribute of an aggregate density profile is market intensity. The grid entries of the aggregate density profile represent the maximum satisfaction value among those profiles occupying each price/size grid cell. Of course, the display could be modified so that some other statistic relating to the satisfaction values is calculated or aggregated and available for output to a trader (e.g., minimum, average, medium, most frequently occurring, etc.).

The satisfaction density profile may also be used to execute a trading strategy, rather than individual trades. Thus, a trader may define a set of trades that should be implemented, and of which individual trades are a part. As pieces of the strategy are implemented, an overall optimization may refine or loosen the requirements for subsequent trades. For example, if a trader wishes to establish a matched book, the trader would create a sell satisfaction density profile representing the repurchase agreement and respective reverse repurchase agreement, and indicate that these profiles are to be linked together. This linking process can be accomplished, for example, by utilizing a connection matrix and performing matrix manipulation on the two profiles. It will be apparent that other, more complex, linked trades can be accomplished in the same manner.

This technique provides a rich means of price discovery. In steady-state operation, where all feasible matches have been performed and the system is awaiting the next profile input, there will exist a group of unfilled buy satisfaction density profiles and a group of unfilled sell satisfaction density profiles, with no overlap between the two groups (otherwise a match would be performed). The two-dimensional price/size region between these groups is denoted the “spread region,” and depicts, at each value of size, the spread between the highest non-zero buy satisfaction profile price and the lowest non-zero sell satisfaction profile price. This depiction of the aggregate of unfilled satisfaction profiles is a significant generalization of the market quotes currently provided by exchanges and market makers, and provides substantially greater price discovery across the full range of trade sizes than is contained in the current quotations of best-bid and best-offering prices and corresponding sizes.

In further embodiments, additional variables (or parameters) can be included that have an effect on the satisfaction density profile. For example, an eligibility variable or an urgency variable (or both) could be set by the trader, as explained below. For example, a trader may seek to maintain a matched book, over the course of a trading day, or define limit parameters as to how far from matched he is willing to go, a function of the execution status of other trades, or a combination thereof. To account for these constraints and relationships, the satisfaction density profile of the present invention can be augmented to include two other variables: eligibility and urgency. Both the urgency variable and the eligibility variable can be associated with the satisfaction density profile as a whole (e.g., one value per variable per profile) or with each coordinate of the satisfaction density profile (e.g., one value for each (price, size) coordinate.) The eligibility variable is used to track execution status, and is used to keep track of when matches have occurred, to couple different transactions. The urgency variable represents the degree to which a particular satisfaction value should be either (a) translated in the direction of a more aggressive price, or (b) warped to a more aggressive satisfaction value, or both.

The essential variable terms of agreement between the buyer and seller in a repurchase agreement are the collateral class (e.g., US Treasuries, US agencies, mortgages), collateral identification (e.g., term to maturity), collateral type (e.g., triparty, two-party), pieces, right of substitution, amount of transaction, implied transaction rate (repo rate), term (e.g., overnight, 1 week, 30 days, repo to maturity, etc.) or the Purchase Date and Repurchase Date, and the bank account[s] to which initial payments to be made thereunder are to be credited. Other information material to the transaction include whether the transaction is through an agent (Agency Transaction) and, if so, the identity of the party which is acting as agent and the name, code or identifier of the principal; and any additional terms or conditions of the Transaction.

Thus, there are a number of specific pieces of information unique to a repo transaction. The present invention therefore provides a set of user interfaces for specifying and negotiating a proposed repo transaction, an efficient format. According to a preferred embodiment, the rate, term, right of substitution (ROS), margin, collateral, collateral type and pieces are each provided as a drop down or counter box, with predefined valid selections available by way of manipulation of the graphic user interface elements. The amount, account number, and any proposed message are entered manually, while the identifications of the parties are provided automatically. The term is preferably automatically translated into a starting and ending date with the present date as a preset reference point, but which may be overridden for future transactions.

According to repo practice, on the Purchase Date for a transaction, Seller transfers the Purchased Securities to Buyer, or its agent against the payment of the Purchase Price, less Haircut by the Buyer. On the Repurchase date, the Buyer transfers to the Seller or its agent Equivalent Securities against the payment of the Repurchase Price by Seller. The equivalence of securities may be subject to negotiation, and for example the securities may be required to be an identical issue, or merely equivalent in issuer, value and maturity.

Typically, if at any time either party has a Net Exposure in respect of the other party, it may by notice to the other party require the other party to make a Margin Transfer to it of an aggregate amount or value at least equal to that Net Exposure. Thus, the collateral is repriced to market, and the collateral value plus haircut is maintained or a cash transfer effected. This may be calculated on a counterparty basis, rather than a transaction basis.

Typically, income from the securities is considered property of the seller, and indeed the seller often incurs the risk of issuer nonpayment of interest. Thus, in coupon securities, the coupon value is paid to the seller, or interest thereon paid to the seller. In discount securities, the price calculations account for interest accrual. The system according to the present invention preferably calculates values and yields (or allows for presentation of such values and yields from a client system). Indeed, the exchange system according to the present invention preferably provides a database of various issues, as well as various statistics relating thereto, and may generate appropriate information defining required interest payments.

The present invention also facilitates integration of rollover (revolving) transactions, wherein parties may test the repo market with securities that would otherwise roll into a subsequent overnight repo transaction. This therefore allows such rollovers to occur at market rates.

Known systems are provided for internal management of repo and reverse activity within a trading house. These systems facilitate automate internal processing of Repurchase Agreements. See, GovREPO, from Horizon Global Trading Inc., (New York, N.Y.), CSI Repurchase Agreement System, Commitment Software, Inc. (Miami, Fla.). Separate systems by broker dealers, such as Canter Fitzgerald, quote repo transactions. However, none of these systems seeks to automate the process, as does the present invention.

In order to maintain anonymity of participants, while nevertheless publishing quotes in a market wherein counterparty credit risk is relevant, the method disclosed in U.S. Pat. No. 5,373,055, expressly incorporated herein by reference, may be employed.

U.S. Pat. No. 5,802,499 (Sampson, et al., Sep. 1, 1998), expressly incorporated herein by reference, relates to a method and system for providing credit support to parties associated with derivative and other financial transactions. A computer-based information network is provided for managing credit exposure between counterparties to a plurality of credit support agreements. The systems store various types of information including information representative of assets of counterparties to a plurality of credit support agreements for use in covering credit exposures therebetween over a specified time period, and the plurality of credit support agreements. The systems process the information representative of the assets in order to effectively reflect a movement of certain of the assets to cover the credit exposures over the specified time period. An asset movement optimization process is used for determining an optimal movement of certain of said assets to cover credit exposures over the specified time period. This system may form a part of an automated exchange, serving as a prescreen for presentation of bids to a trader. Thus, if a set of rules are applied which would not permit a transaction to occur, the trader might not be informed that the bid exists, and thus the anonymity of the parties is maintained. Thus, it is an aspect of the invention that, while bona fide potential transactions require identification of counterparties and communication therebetween, the disclosure of private information may be limited to those with a need to know. This absolute screening may be tempered by providing partial anonymous information, if the bid does not meet acceptance criteria. The reason for unacceptability may optionally be coded. In order to prevent traders from abusing the system, a counterparty may define other traders with whom he will not deal, or who will have no access to his bid information. Thus, an errant user will soon discover that he has been boycotted from the system. Obviously, this ability to exclude potential counterparties must be employed judiciously, since any consummated trade is considered advantageous, and since by limiting the potential market, transaction costs rise and liquidity falls.

The screening system according to the present invention is based, for example, on amount of gross credit exposure between potential counterparties, credit worthiness of potential counterparty, effect of a haircut in abating potential risks, risk/benefit involved in a particular type of collateral, degree to which collateral is special or part of a strategy which mitigates risk, history of trades with potential counterparty, and profitability of the trade, or a subcombination thereof.

In view of the above described problems associated with known automated trading systems, it is an object of the present invention to provide an exchange system which facilitates matching of buyer and seller by initially providing search information to inform potential counterparties of mutual interest in a transaction, but optionally maintains potential counterparty anonymity until one party seeks to initiate contact with the other to finalized negotiatiations for the deal. The system then provides a list of potential opportunities, any one of which may be selected to activate a communications link between potential counterparties, for disclosure of identity and other information. Typically, the communications are free form, but may include coded data or tokens. A transaction is only completed when both sets of transaction parameters are agreed upon by all parties to the transaction.

It is a further objective of the present invention to provide a negotiated trading system which enables users to enter expressions of interest with respect to a type of transaction, and to allow other traders to evaluate a variety of offers before consummating a transaction.

It is another objective of the present invention to provide a negotiated trading system which identifies parties who are potentially interested in transacting business and place these parties in communication with one another.

It is another object of the present invention to provide a negotiated trading system that accommodates the numerous complex and non-standardized exposure evaluation procedures of various financial institutions within a single automated exchange system while allowing preservation of the confidentiality of these procedures.

Yet another object of the present invention is to provide a list of opportunities for a trader, sorted by a prioritization scheme which weights importance to the trader, which facilitates communication between traders to conclude negotiations of the deal. The identity of potential counterparties may be preserved until just before the deal has been struck.

The aforementioned objects, as well as other objects, of the present invention are achieved by providing a negotiated matching system with a sorted list of opportunities, each element on the list identifying the nature of the opportunity and linking to a communications session with a potential counterparty.

The negotiated exchange system according to the present invention includes a plurality of remote terminals associated with respective potential counterparties and a communications network for permitting communication between the remote terminals and a matching computer and between the remote terminals themselves. Each user enters a first set of desired opportunity parameters including ranking and other information into his or her remote terminal. The sorting and filtering may be conducted centrally, or under control of a client system, or some combination thereof. The computer uses a set of transaction parameters (ranking data, price data, size data and other parameters or attributes) from each user to sort potential transactions with potential counterparties in priority order.

Typically, the system does not act to match and automatically close transactions, but rather to facilitate transactions by identifying potential counterparties and facilitating communication therebetween, and by, after negotiation of deal terms, communicating with back-office systems the terms of the deal.

The system according to the present invention also distributes the bid and offer information entered into the system to the users of the system. Prior to their display to the users, the bids and offers may be filtered using the ranking data entered by the users, thereby limiting the bids and offers displayed to individual users. When a user sees a desirable bid or offer on his or her screen, the user may “hit” the bid or “lift” the offer, thereby opening a communications session with the respective potential counterparty.

The negotiated exchange system according to the present invention may be implemented to filter information and communications to permit dealing only between parties who are mutually acceptable counterparties based on predetermined information.

A benefit of the negotiated exchange system according to the present invention is that the complex and confidential credit evaluation and risk management procedures of various financial institutions may be segregated from the bid and communications functions, and thus does not require standardization of institution financial practices, and allows the institutions to keep their credit practices confidential.

A method of identifying potential counterparties to a transaction according to the present invention includes the steps of receiving ranking data and transaction data from traders at a plurality of terminals; ranking the transaction data to identify, for each user, likely acceptable transactions with potential counterparties, and allowing the bidder to then communcate with the offeror seeking to complete the transaction through a negotiation.

Various additional advantages and features of novelty which characterize the invention are further pointed out in the claims that follow. However, for a better understanding of the invention and its advantages, reference should be made to the accompanying drawings and descriptive matter which illustrate and describe preferred embodiments of the invention.

### BRIEF DESCRIPTION OF THE DRAWINGS

FIG. 1 provides a diagram of one configuration of the negotiated exchange system according to the present invention.

FIG. 2 provides a flow chart of the operation of the negotiated exchange system according to the present invention.

FIGS. 3 and 4 provide illustrations of sample screens displayed on the terminal displays of dealer and investor screens, respectively.

### DETAILED DESCRIPTION OF THE PREFERRED EMBODIMENTS

The negotiated exchange system according to the present invention will now be described with reference to the accompanying drawings.

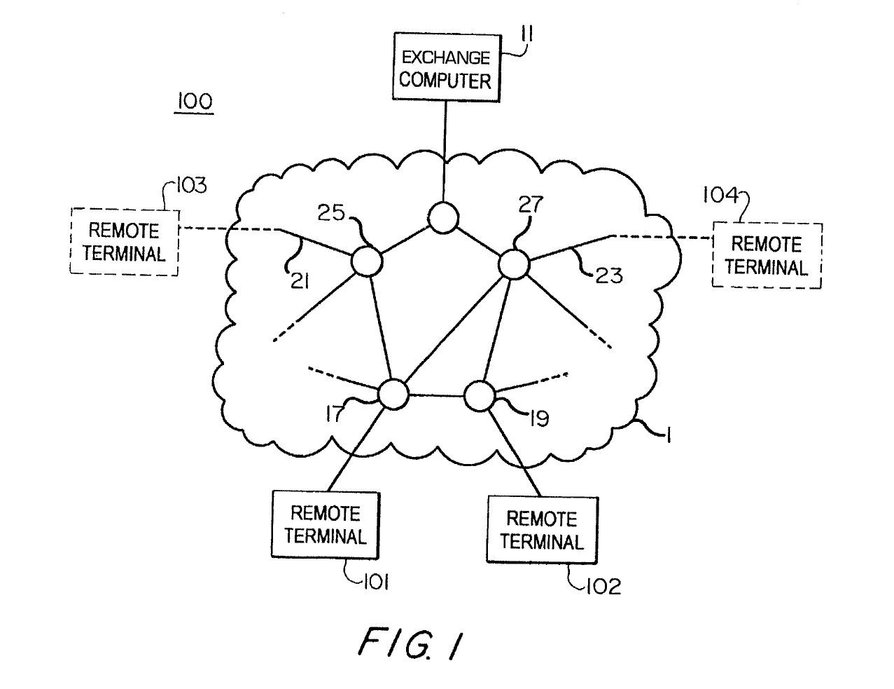

With reference to FIG. 1, a first embodiment of the negotiated exchange system 100 according to the present invention includes a central computer 11 and remote terminals 101 and 102. The system contemplates a plurality of remote terminals whereby a large number of users have simultaneous access to the negotiated exchange system; however, for description purposes, two remote terminals 101 and 102 and optional remote terminals 103 and 104 are shown in FIG. 1.

It is further noted that a completely distributed system is possible, with no central control system; however, this increases processing and communications burdens on the remote terminals, and potentially reduces privacy and anonymity.

The central computer 11 is connected to the remote terminals 101 and 102 through a communication network 1. Nodes 17 and 19 may also be inserted into the communication network 1 between matching computer 11 and remote terminals 101 and 102. These nodes 17 and 19 may be intelligent nodes which, for example, perform filtering operations or passive nodes (repeater stations) which merely transmit information from the matching computer 11 to the remote terminals 101 and 102. Connectors 21 and 23 maybe used to connect additional remote terminals (e.g., 103 and 104) and/or additional nodes (e.g., 25 and 27) to the network.

Remote terminals 101 and 102 also are connected via communication network 1. Remote terminals 101 and 102 may communicate with each other via network 1, optionally with or without involvement of the central computer 11. For example, communications between remote terminals 101 and 102 may take place using a known Internet chat system, h.323 audio and/or video conferencing system, or the like. Alternately, the central computer 11 may intercede in all communications, for example to preserve anonymity prior to contact, to trap deal parameters for memorialization thereof, and to provide a standard and consistent platform. The communications system may also include special functions adapted for repo and reverse trading, making communications activities more efficient.

The communication network 1 may also include switching centers (not shown) which are configured as a conventional packet switching network so that, if the most direct route between remote terminals 101 and 102 becomes inoperable due to a malfunction in a part of the system, the routing can be varied to enable communication between the terminals 101 and 102. It will be appreciated that, in some situations, terminals 101 and 102 will be distributed around the globe.

The negotiated exchange system according to the present invention may be realized using a number of different network configurations. Where filter rules are uploaded, these may be processed centrally or regionally. For example, where nodes 17 and 19 are passive (repeaters), central computer 11 performs all filter operations for the system. Where nodes 17 and 19 are intelligent nodes, these nodes may perform some filtering functions, while additional filtering may take place in the central computer 11. Filtering may also be performed by remote terminals 101 and 102.

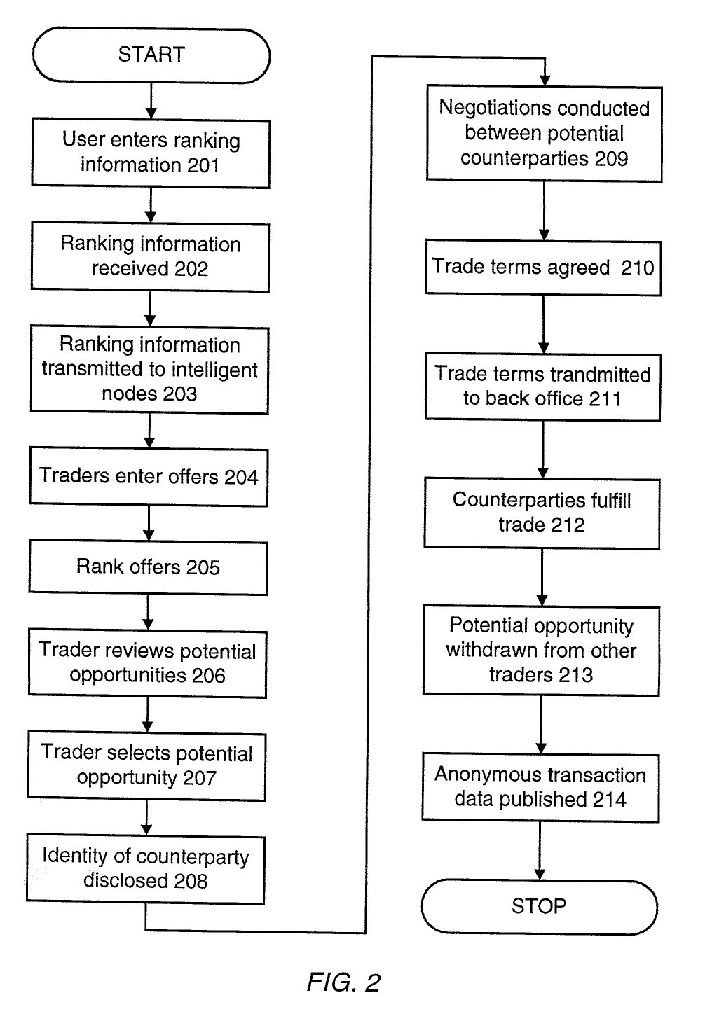

FIG. 2 provides a flow chart which illustrates the overall operation of the negotiated exchange system according to the present invention shown in FIG. 1 (with intelligent nodes such as 17 and 19). The functions of the central computer 11 as described below, may be performed using a configuration of hardware components, software components, or both.

Initially, each user enters ranking information 201 (as described below with reference to FIG. 1). This information may be processed locally, or uploaded to the central computer 11 and stored 202. If intelligent 17, 19 nodes are provided, the central computer 11 then transfers the ranking information to these nodes 203. Traders enter offers into the remote terminals for broadcast to other traders 204. These offers necessarily require a negotiation, since counterparty issues are material. The transaction opportunities are ranked 205. A trader may then investigate an offer 206 by selecting the representation of that offer, commencing a real time communication/negotiation session with the potential counterparty. After the counterparties agree on terms, these terms may be captured by the remote terminals to define a trade, or the confirmations may be made through a separate system, not shown in the figures.

In order to properly rank the transaction 205, the various factors are evaluated to determine a likelihood of transaction. If one or both of the potential counterparties indicates a low likelihood of a transaction, the offer is either ranked low on the potential bidder's list, or filtered and does not appear at all.

A trader then selects one of the opportunities 207, and establishes a communication session with the potential counterparty, preferably in real time. During this communication, the identity of the counterparties is disclosed 208, and the terms of a trade are negotiated 209. When the terms are established, these are then transmitted to a back office system for trade execution 210 and trade tickets are printed for each party to confirm the transaction. Preferably, the trade information is communicated to the central computer 11, which then communicates with a back office system for each respective counterparty 211. The counterparties then proceed to fulfill the trade 212. When the trade is confirmed, the central computer 11 transmits a message to all the remote terminals 17, 19, or only those which displayed the opportunity, to indicate that the opportunity is no longer available 213. Optionally, terms of the deal may be published, in order to increase market transparency 214. Typically, anonymity is maintained except between the trading counterparties.

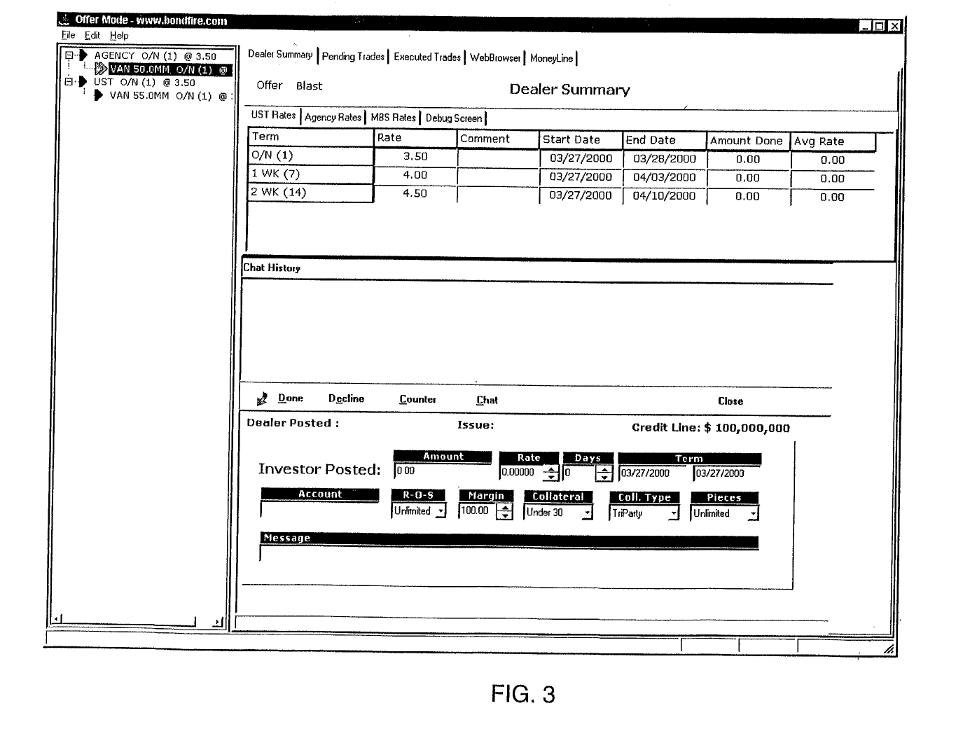

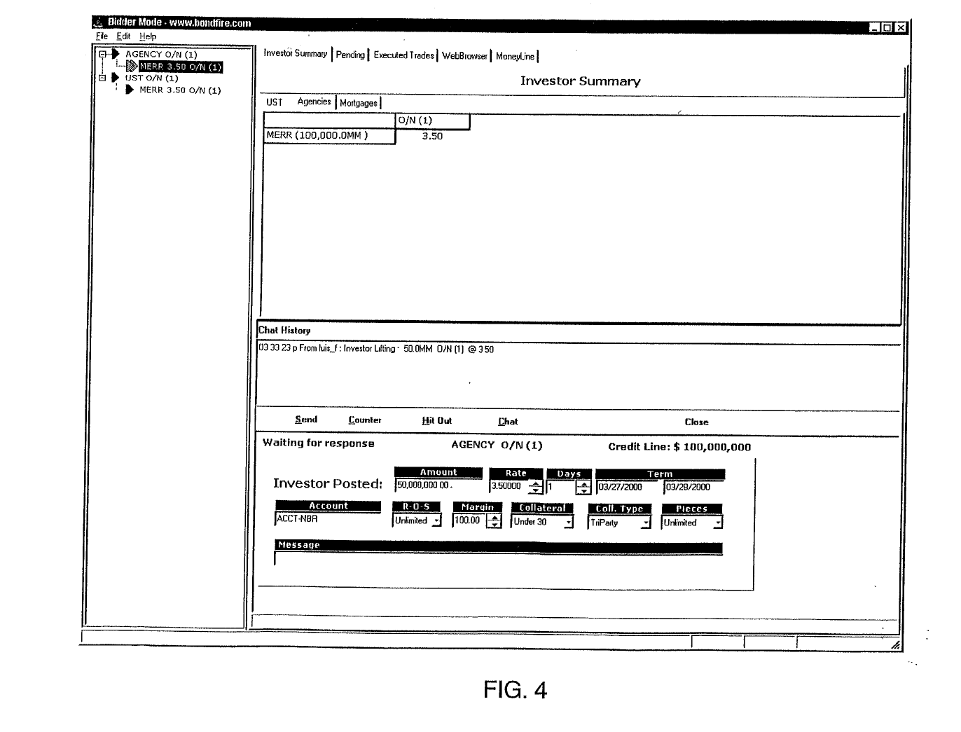

FIG. 3 shows a dealer summary screen, having in a left pane two types opportunities listed by that dealer, agency overnight and US Treasury overnight. The dealer seeks to repo the securities, and thus finance his activities. As seen at the top of the dealer screen, five tabs are present: Dealer summary, Pending trades, executed trades, web browser and moneyline. Likewise, the investor summary screen, shown in FIG. 4, shows in a left pane two types available opportunities, agency overnight and US Treasury overnight. The investor seeks to enter into a repo with the securities as collateral, and thus gain investment income from cash. As seen at the top of the investor screen, five tabs are present: Dealer summary, Pending trades, executed trades, web browser and moneyline. By selecting one of the presented opportunities, the investor may communicate with the dealer, to negotiate the trade, for example, the interest rate, haircut, and possibly other aspects of the transaction. The investor remains anonymous and invisible until he contacts the dealer.

As shown in the investor summer screen, a chat history is available, organized by opportunity. The chat sessions identify the counterparty. The content of the chat message may be defined by the pick lists present at the bottom pf the screen, which are context sensitive for the respective security, e.g., US Treasuries, agencies and mortgages.

The negotiations between potential counterparties to a transaction may take the form of pre-defined, structured dialogue (e.g., pre-defined sentences), free dialogue, or a combination of both as desired by the users and implementers of the system. A structured dialogue format may be desirable to increase communications efficiency, and indeed allow automated translation into various languages. The potential counterparty negotiations which take place in the negotiated matching system according to the present invention may be accomplished using a pre-formatted display window, text format entered on a keyboard, through a speech recognition system which converts spoke words into text, or the like. Communication may also be accomplished using a visual format in which the remote terminal of each user is provided with a video camera and microphone to enable traders to communicate “face-to-face.” Possible video communication systems for use in the negotiated matching system according to the present invention are described in U.S. Pat. Nos. 4,525,779; 4,531,184; 4,555,781; and 5,034,916 which describe several types of conversational video systems.

While the present invention has been particularly described with reference to the preferred embodiments, it should be readily apparent to those of ordinary skill in the art that changes and modifications in form and details may be made without departing from the spirit and scope of the invention. It is intended that the appended claims include such changes and modifications.

What is claimed is:

1. A repurchase agreement trading system comprising:
(a) a plurality of trading terminals, each having a user interface comprising a display and keyboard; and
(b) a central processor, for establishing communications between said trading terminals;
wherein each of said trading terminals presents a hierarchal list of repurchase agreement opportunities, and wherein a user at a trading terminal can select one of said repurchase agreement opportunities and communicate directly with a potential repurchase agreement counterparty about the respective repurchase agreement opportunity.

2. The system according to claim 1, wherein a user remains anonymous until he communicates with a potential counterparty.

3. The system according to claim 1, wherein the hierarchal list is sorted according to a user defined criteria.

4. The system according to claim 1, wherein the hierarchal list is filtered according to a user defined criteria.

5. The system according to claim 1, wherein the central processor transmits information defining counterparty trading tickets upon successful conclusion of negotiatiosn between counterparties.

6. The system according to claim 1, wherein the plurality of trading terminals are segregated between dealers and investors.

7. A negotiated exchange for facilitating transactions between potential counterparties and enabling communication between the parties to negotiate the terms of the transaction, said system comprising:
a central computer;
a plurality of remote terminals corresponding to a plurality of users, said remote terminals enabling said users to enter transaction data into the system; and
a communications network for transmitting negotiating messages between pairs of said remote terminals in response to control signals from a respective one of the remote terminals;
wherein a party associated with a transaction is anonymous until communications are established through said communications network, for transmitting negotiating messages.

8. A negotiated exchange according to claim 7, wherein said transaction data include ranking data whereby each user ranks potential counterparties based on objective criteria, said ranking data indicative of the extent to which the user wishes to deal with each potential counter party.

9. A negotiated exchange according to claim 7, wherein said negotiating messages transmitted between said remote terminals comprise messages having a free-style format.

10. A negotiated exchange according to claim 7, wherein said negotiating messages transmitted between said remote terminals comprise messages having a predetermined format.

11. A negotiated exchange according to claim 7, wherein said transaction data include ranking data whereby each user ranks potential counterparties based on subjective criteria, said ranking data indicative of the extent to which the user wishes to deal with each potential counter party.

12. A negotiated exchange according to claim 7, wherein said negotiating messages transmitted between said remote terminals comprise free-style electronic dialogue which is displayed on each user's remote terminal.

13. A negotiated exchange according to claim 12, wherein said electronic dialogue is unstructured, thereby permitting the parties to negotiate all terms of the transaction.

14. A repurchase agreement exchange method comprising providing a plurality of user terminals, each displaying a list of offers for repurchase agreements of securities, receiving from a user terminal a user entry portion for defining potential repurchase agreement terms, and communicating with a potential counterparty, based on an identification of a respective offer, through a negotiation communications interface.

15. The method according to claim 14, wherein a record is communicated between at least two user terminals comprising particulars of a proposed repurchase agreement, comprising an amount, a rate, a term, and an identification of collateral.

16. The method according to claim 15, wherein the particulars further comprise a margin.

17. The method according to claim 15, wherein the identification of collateral comprises an issuer and a maturity range.

18. The method according to claim 17, wherein the identification of the collateral further comprises a number of instruments representing the amount, and the record further identifies a disposition of collateral and a right of collateral substitution.

19. The method according to claim 15, wherein the record further comprises a free form text field.

20. The method according to claim 15, wherein a bid record is compared with an ask record to selectively indicate a difference therebetween.

21. The method according to claim 15, wherein a proposed modification of the particulars is extracted from the free form text field.
